(19) United States
(12) Patent Application Publication
(10) Pub. No.: US 2005/0002341 A1
(43) Pub. Date: Jan. 6, 2005

(54) Apparatus and method for authorizing gateway

(75) Inventors: Hak-goo Lee, Suwon-si (KR); Kang-suk Lee, Seongnam-si (KR); Yong-jun Lim, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/845,618

(22) Filed: May 14, 2004

(30) Foreign Application Priority Data
May 14, 2003 (KR) 2003-30508

(51) Int. Cl. H04L 12/28; H04L 12/66

(52) U.S. Cl. 370/254; 370/401

(57) ABSTRACT

An apparatus and method for authorizing a gateway are provided. The apparatus includes a gateway function determiner, which determines whether a gateway on a predetermined network performs a particular function for a predetermined node based on a network database including information on each node managed by the gateway and information indicating a function performed by the gateway for the node; and a gateway authorizer, which authorizes the gateway to perform the particular function for the predetermined node when the gateway function determiner determines that the gateway performs the particular function for the predetermined node.

### CROSS-REFERENCE TO RELATED APPLICATIONS

This application claims the priority of Korean Patent Application No. 2003-30508, filed on May 14, 2003, in the Korean Intellectual Property Office, the disclosure of which is incorporated herein in its entirety by reference.

### BACKGROUND OF THE INVENTION

1. Field of the Invention

The present invention relates to an apparatus and method for authorizing a gateway.

2. Description of the Related Art

In conventional wired/wireless data communication, an Internet service provider (ISP) terminal one-sidedly provides various Internet services, such as a home agent service, a domain name server service, and a private security service, to a static terminal at a home or a mobile terminal. As a result, most traffic is concentrated on an ISP terminal, so the ISP terminal is burdened with a great load. In addition, with a rapid increase in the number of Internet users, an ISP terminal needs to be continuously updated to accommodate the increasing users. Consequently, an ISP terminal has too many loads to handle.

An ISP terminal provides a private security function using an international communication security protocol, i.e., an Internet protocol security protocol (IPSEC). Since the IPSEC is a common security method, when a security technique is leaked out, great damage occurs. In addition, since the IPSEC is a universal technique, it is easily hacked.

Various types of mobile terminals are used at home and are small and light-weight. Since they are limited in volume and weight, it is difficult to mount a high-speed processor or large-capacity of memory on them. Accordingly, such small and light-weight mobile terminals cannot perform functions requiring a lot of resources. Even if they can perform the functions, the functions cannot be smoothly performed.

### SUMMARY OF THE INVENTION

The present invention provides an apparatus and method for allowing a gateway at home to perform various functions of an Internet service provider (ISP) terminal, thereby preventing excessive traffic from being concentrated on the ISP terminal.

The present invention also provides an apparatus and method for allowing a gateway to directly communicate with a node without passing through an ISP terminal, thereby firmly ensuring private security.

The present invention also provides an apparatus and method for allowing a gateway to perform a partial node function requiring a lot of resources so that a node can freely perform various tasks requiring a lot of resources regardless of its characteristics.

Consistent with an aspect of the present invention, there is provided an apparatus for authorizing a gateway. The apparatus includes a gateway function determiner, which determines whether a gateway on a predetermined network performs a particular function for a predetermined node based on a network database including information on each node managed by the gateway and information indicating a function performed by the gateway for the node; and a gateway authorizer, which authorizes the gateway to perform the particular function for the predetermined node when the gateway function determiner determines that the gateway performs the particular function for the predetermined node.

Consistent with another aspect of the present invention, there is provided an apparatus for performing a function for a node in a gateway. The apparatus includes a gateway information providing message transmitter, which transmits a gateway information providing message to an authentication/authorization/accounting server, the gateway information providing message including information on each node managed by the gateway on a predetermined network and information indicating a function performed by the gateway for the node; a gateway information acknowledgement message receiver, which receives a gateway information acknowledgement message from the authentication/authorization/accounting server, the gateway information acknowledgement message indicating that the information on each node managed by the gateway and the information indicating a function performed by the gateway for the node has been confirmed; and a function performing unit, which performs the function for a predetermined node when the gateway information acknowledgement message receiver receives the gateway information acknowledgement message.

Consistent with still another aspect of the present invention, there is provided an apparatus for performing a home agent function for a node in a gateway. The apparatus includes a gateway information providing message transmitter, which transmits a gateway information providing message to an authentication/authorization/accounting server, the gateway information providing message including information on each mobile node managed by the gateway on a predetermined network and information indicating whether the home agent function is performed by the gateway for the mobile node; a gateway information acknowledgement message receiver, which receives a gateway information acknowledgement message from the authentication/authorization/accounting server, the gateway information acknowledgement message indicating that the information on each mobile node managed by the gateway and the information indicating whether the home agent function is performed by the gateway for the mobile node has been confirmed; and a home agent function performing unit, which performs the home agent function for a predetermined mobile node when the gateway information acknowledgement message receiver receives the gateway information acknowledgement message.

Consistent with still another aspect of the present invention, there is provided an apparatus for performing a domain name server function for a node in a gateway. The apparatus includes a gateway information providing message transmitter, which transmits a gateway information providing message to an authentication/authorization/accounting server, the gateway information providing message including information on each node managed by the gateway on a predetermined network and information indicating whether the domain name server function is performed by the gateway for the node; a gateway information acknowledgement message receiver, which receives a gateway information acknowledgement message from the authentication/authorization/accounting server, the gateway information acknowledgement message indicating that the information on each node managed by the gateway and the information indicating whether the domain name server function is performed by the gateway for the node has been confirmed; and a domain name server function performing unit, which performs the domain name server function for a predetermined node when the gateway information acknowledgement message receiver receives the gateway information acknowledgement message.

Consistent with still another aspect of the present invention, there is provided an apparatus for performing a nickname server function for a node in a gateway. The apparatus includes a gateway information providing message transmitter, which transmits a gateway information providing message to an authentication/authorization/accounting server, the gateway information providing message including information on each node managed by the gateway on a predetermined network and information indicating whether a nickname server function is performed by the gateway for the node; a gateway information acknowledgement message receiver, which receives a gateway information acknowledgement message from the authentication/authorization/accounting server, the gateway information acknowledgement message indicating that the information on each node managed by the gateway and the information indicating whether the nickname server function is performed by the gateway for the node has been confirmed; and a nickname server function performing unit, which performs the nickname server function for a predetermined node when the gateway information acknowledgement message receiver receives the gateway information acknowledgement message.

Consistent with still another aspect of the present invention, there is provided an apparatus for performing a partial node function for a node in a gateway. The apparatus includes a gateway information providing message transmitter, which transmits a gateway information providing message to an authentication/authorization/accounting server, the gateway information providing message including information on each node managed by the gateway on a predetermined network and information indicating whether the partial node function is performed by the gateway for the node; a gateway information acknowledgement message receiver, which receives a gateway information acknowledgement message from the authentication/authorization/accounting server, the gateway information acknowledgement message indicating that the information on each node managed by the gateway and the information indicating whether the partial node function is performed by the gateway for the node has been confirmed; and a partial node function performing unit, which performs the partial node function for a predetermined node when the gateway information acknowledgement message receiver receives the gateway information acknowledgement message.

Consistent with still another aspect of the present invention, there is provided a method of authorizing a gateway. The method includes determining whether a gateway on a predetermined network performs a particular function for a predetermined node based on a network database including information on each node managed by the gateway and information indicating a function performed by the gateway for the node; and when it is determines that the gateway performs the particular function for the predetermined node, authorizing the gateway to perform the particular function for the predetermined node.

Consistent with still another aspect of the present invention, there is provided a method of performing a function for a node in a gateway. The method includes transmitting a gateway information providing message to an authentication/authorization/accounting server, the gateway information providing message including information on each node managed by the gateway on a predetermined network and information indicating a function performed by the gateway for the node; receiving a gateway information acknowledgement message from the authentication/authorization/accounting server, the gateway information acknowledgement message indicating that the information on each node managed by the gateway and the information indicating a function performed by the gateway for the node has been confirmed; and performing the function for a predetermined node when the gateway information acknowledgement message is received.

Consistent with still another aspect of the present invention, there is provided a method of performing a home agent function for a node in a gateway. The method includes transmitting a gateway information providing message to an authentication/authorization/accounting server, the gateway information providing message including information on each mobile node managed by the gateway on a predetermined network and information indicating whether the home agent function is performed by the gateway for the mobile node; receiving a gateway information acknowledgement message from the authentication/authorization/accounting server, the gateway information acknowledgement message indicating that the information on each mobile node managed by the gateway and the information indicating whether the home agent function is performed by the gateway for the mobile node has been confirmed; and performing the home agent function for a predetermined mobile node when the gateway information acknowledgement message is received.

Consistent with still another aspect of the present invention, there is provided a method of performing a domain name server function for a node in a gateway. The method includes transmitting a gateway information providing message to an authentication/authorization/accounting server, the gateway information providing message including information on each node managed by the gateway on a predetermined network and information indicating whether the domain name server function is performed by the gateway for the node; receiving a gateway information acknowledgement message from the authentication/authorization/accounting server, the gateway information acknowledgement message indicating that the information on each node managed by the gateway and the information indicating whether the domain name server function is performed by the gateway for the node has been confirmed; and performing the domain name server function for a predetermined node when the gateway information acknowledgement message is received.

Consistent with still another aspect of the present invention, there is provided a method of performing a nickname server function for a node in a gateway. The method includes transmitting a gateway information providing message to an authentication/authorization/accounting server, the gateway information providing message including information on each node managed by the gateway on a predetermined network and information indicating whether the nickname server function is performed by the gateway for the node; receiving a gateway information acknowledgement message from the authentication/authorization/accounting server, the gateway information acknowledgement message indicating that the information on each node managed by the gateway and the information indicating whether the nickname server function is performed by the gateway for the node has been confirmed; and performing the nickname server function for a predetermined node when the gateway information acknowledgement message is received.

Consistent with still another aspect of the present invention, there is provided a method of performing a partial node function for a node in a gateway. The method includes transmitting a gateway information providing message to an authentication/authorization/accounting server, the gateway information providing message including information on each node managed by the gateway on a predetermined network and information indicating whether the partial node function is performed by the gateway for the node; receiving a gateway information acknowledgement message from the authentication/authorization/accounting server, the gateway information acknowledgement message indicating that the information on each node managed by the gateway and the information indicating whether the partial node function is performed by the gateway for the node has been confirmed; and performing the partial node function for a predetermined node when the gateway information acknowledgement message is received.

### BRIEF DESCRIPTION OF THE DRAWINGS

The above and other features and advantages of the present invention will become more apparent by describing in detail exemplary embodiments thereof with reference to the attached drawings in which:

FIG. 1 shows a network environment to which the present invention is applied;

FIG. 2 is a diagram of an apparatus for authorizing a gateway consistent with an embodiment of the present invention;

FIG. 3 is a diagram of an apparatus for performing a function for a node in a gateway consistent with an embodiment of the present invention;

FIG. 4 is a diagram of an apparatus for performing a home agent function in a gateway consistent with an embodiment of the present invention;

FIG. 5 is a diagram of an apparatus for performing a domain name server (DNS) function in a gateway consistent with an embodiment of the present invention;

FIG. 6A is a diagram of an apparatus for performing a nickname server function in a gateway consistent with an embodiment of the present invention;

FIG. 6B shows an example of an IP address/nickname mapping table used in the present invention;

FIG. 7 is a diagram of an apparatus for performing a partial node function in a gateway consistent with an embodiment of the present invention;

FIG. 8 illustrates a private security function consistent with an embodiment of the present invention;

FIGS. 9A and 9B are flowcharts of a method of authorizing a gateway consistent with an embodiment of the present invention;

FIG. 10 is a flowchart of a method by which a gateway performs a function for a node, consistent with an embodiment of the present invention;

FIGS. 11A and 11B are flowcharts of a method by which a gateway performs a home agent function consistent with an embodiment of the present invention;

FIGS. 12A and 12B are flowcharts of a method by which a gateway performs a DNS function consistent with an embodiment of the present invention;

FIGS. 13A and 13B are flowcharts of a method by which a gateway performs a nickname server function consistent with an embodiment of the present invention; and

FIGS. 14A and 14B are flowcharts of a method by which a gateway performs a partial node function consistent with an embodiment of the present invention.

### DETAILED DESCRIPTION OF THE INVENTION

Hereinafter, exemplary embodiments of the present invention will be described in detail with reference to the attached drawings.

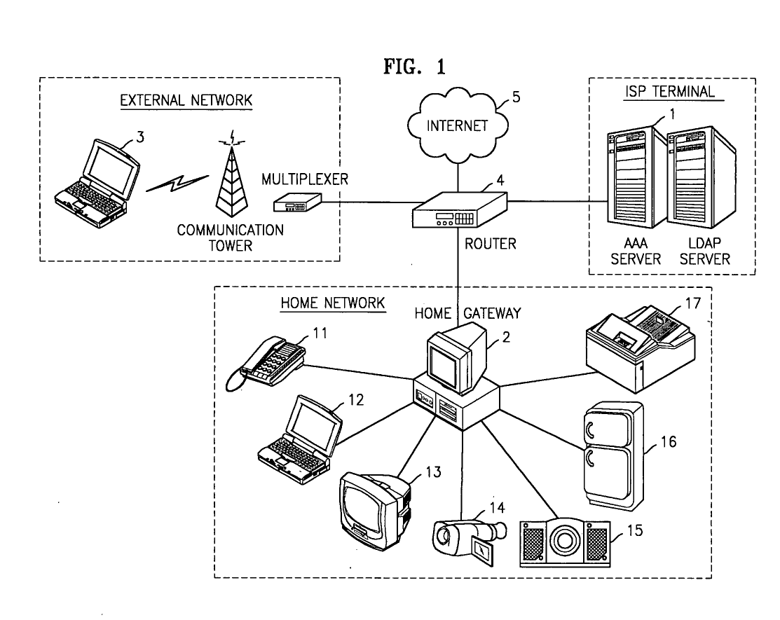

FIG. 1 shows a network environment to which the present invention is applied. Referring to FIG. 1, the network environment includes an Internet service provider (ISP) terminal, a home network, an external network, a router 4, and Internet 5.

An ISP is a company which provides an Internet access service, a web site construction service, and a web hosting service to individual persons, enterprises, etc. A conventional ISP terminal performs an authentication/authorization/accounting (AAA) function, a home agent function, a domain name server (DNS) function, a private security function, etc. The ISP terminal consistent with the present invention includes an AAA server 1 and a lightweight directory access protocol (LDAP) server. The AAA server 1 authenticates a subscriber, authorizes the subscriber to use a predetermined Internet service, and accounts for the subscriber's activity according to time during which the subscriber uses the predetermined Internet service. The AAA server 1 is essential to the ISP terminal. The AAA server 1 may use Remote Authentication Dial-In User Service (RADIUS) as a protocol but preferably uses a next generation AAA protocol, i.e., Diameter, in order to accommodate a rapidly increasing number of users.

LDAP is a protocol allowing a location of a file or an apparatus to be found on a network. The LDAP server stores a huge amount of AAA information. Appropriate AAA information is found using the LDAP. The ISP terminal of the present invention performs the AAA function only, thereby having a reduced load as compared to a load occurring when various functions are performed.

A home network is a network installed at a home and includes a home gateway 2 and various electric home appliances 11 through 17. The home gateway 2 performs functions performed by a conventional ISP terminal, i.e., a home agent function, a DNS function, a private security function, etc. In addition, the home gateway 2 performs a nickname server function and a partial node function.

The external network is another network and may be a wired network or a wireless network as shown in FIG. 1. In a present wireless communication environment, a wireless network uses a code division multiple access (CDMA), a general packet radio service (GPRS), or a universal mobile telecommunications system (UMTS). When the external network is a wireless network, a multiplexer and a communication tower exist within a single communication cell, and a plurality of mobile nodes access the communication tower. A mobile node may be a laptop computer or a wireless terminal such as a personal digital assistant (PDA), as shown in FIG. 1.

The router 4 connects the ISP terminal to a plurality of networks using Internet services provided by the ISP. Each node on the plurality of networks accesses the Internet 5 via the router 4.

The home network denotes a network installed at a home but does not exclude networks installed other places. Accordingly, hereinafter, the home network is generalized as a network, and a home gateway existing on the home network is generalized as a gateway.

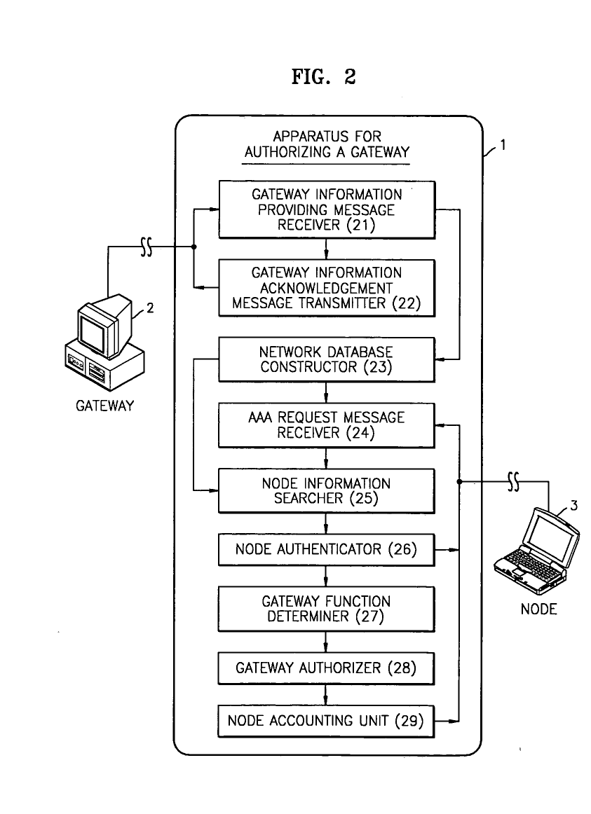

FIG. 2 is a diagram of an apparatus for authorizing a gateway consistent with an embodiment of the present invention. Referring to FIG. 2, the apparatus for authorizing a gateway includes a gateway information providing message receiver 21, a gateway information acknowledgement message transmitter 22, a network database constructor 23, an AAA request message receiver 24, a node information searcher 25, a node authenticator 26, a gateway function determiner 27, a gateway authorizer 28, and a node accounting unit 29. The apparatus for authorizing a gateway is installed in the AAA server 1.

The gateway information providing message receiver 21 receives a gateway information providing message from the gateway 2 on a predetermined network. The gateway information providing message includes information on a node managed by the gateway 2 and information indicating a function performed by the gateway 2 for the node. The node managed by the gateway 2 may be any one of the various electric home appliances 11 through 17 on the network or any type of node 3 on the external network. The function may be any one of a home agent function of managing a mobile node, a DNS function of converting a node's domain name into an IP address, a nickname server function of converting a node's nickname into an IP address, a node security function, and a partial node function. Alternatively, the function may include the home agent function, the DNS function, the nickname server function, the node security function, and the partial node function.

The information on a node managed by the gateway 2 includes an index for identifying the gateway 2, i.e., a network prefix allocated to the gateway 2; and an index for identifying the node, i.e., a media access control (MAC) address recorded in a ROM of an Ethernet card installed in a terminal on the node. The information indicating a function performed by the gateway 2 for a node managed by the gateway 2 includes a value indicating a home agent function, a DNS function, a nickname server function, a node's security function, or a partial node function, for example, “1” for the home agent function, “2” for the DNS function, “3” for the nickname server function, “4” for the node's security function, or “5” for the partial node function.

When the AAA server 1 receives the gateway information providing message from the gateway 2, it is informed of what nodes are managed by the gateway 2 and what function is performed by the gateway 2 for each node.

When the gateway information providing message receiver 21 receives the gateway information providing message, the gateway information acknowledgement message transmitter 22 transmits a gateway information acknowledgement message to the gateway 2. The gateway information acknowledgement message includes information indicating that the gateway information providing message has been received. The gateway 2 can confirm that the AAA server 1 has received the gateway information providing message by receiving the gateway information acknowledgement message.

The network database constructor 23 constructs a network database including the information on a node managed by the gateway 2 and the information indicating a function performed by the gateway 2 for the node, which are included in the gateway information providing message received by the gateway information providing message receiver 21. The AAA server 1 receives gateway information providing messages from a plurality of gateways on a plurality of networks. To facilitate searching the information included in the gateway information providing messages, the received information is made into a database. In other words, the network database includes a network prefix of each gateway, an MAC address of each node corresponding to the network prefix, and a value indicating each function corresponding to the network prefix.

The AAA request message receiver 24 receives an AAA request message from the node 3. The AAA request message includes information on the node 3. When a user using a terminal on a certain node wants to use an Internet service, the user needs to request a permission to use the Internet service from an ISP. The request is implemented by transmitting the AAA request message including information (usually, a MAC address) regarding the user's node to the ISP. When the AAA server 1 receives the AAA request message, it is informed that the node 3 requests a permission to use the Internet service and performs authentication, authorization, and accounting for the node 3.

When the AAA request message receiver 24 receives the AAA request message, the node information searcher 25 searches the network database constructed by the network database constructor 23 for the node information included in the received AAA request message. For fast search, an LDAP is usually used. Information on individual nodes have been registered in the network database. When it is determined that the node 3 having transmitted the AAA request message has been registered in the network database, the node 3 is recognized as having the right to use the Internet service.

When the node information searcher 25 derives the node information, that is, when the node 3 having transmitted the AAA request message is recognized as having the right to use the Internet service, the node authenticator 26 authenticates the node 3 having transmitted the AAA request message.

The gateway function determiner 27 determines what function is performed by the gateway 2 for the authenticated node 3 based on the network database which includes information on each node managed by a gateway and information indicating a function performed by the gateway for each node. As described above, the network database includes a network prefix of each gateway, an MAC address of each node corresponding to the network prefix, and a value indicating each function corresponding to the network prefix. Accordingly, the gateway 2 of the authenticated node 3 and a function performed by the gateway 2 can be identified.

When the function performed by the gateway 2 for the node 3 authenticated by the node authenticator 26 is identified by the gateway function determiner 27, the gateway authorizer 28 authorizes the gateway 2 to perform the function for the node 3. For example, as the result of searching the network database, if it is determined that the gateway 2 performs a home agent function for the node 3, the AAA server 1 lets the gateway 2 take exclusive charge of the home agent function for the node 3. Conventionally, the home agent function is performed by an ISP terminal. However, in the present invention, a gateway takes exclusive charge of the home agent function.

However, if the gateway function determiner 27 determines that the gateway 2 does not performs a certain function for the node 3 authenticated by the node authenticator 26, the gateway authorizer 28 authorizes the ISP terminal to perform this function for the node 3. Since the gateway 2 managing the node 2 cannot perform this function, the ISP terminal performs this function, as in conventional technology.

When the gateway authorizer 28 authorizes the gateway 2 to perform a certain function for the node 3, the node accounting unit 29 charges the node 3 a rate lower than a normal rate. The ISP terminal has excessive traffic since all nodes using services provided by an ISP access the ISP terminal and is very expensive. However, since nodes only managed by the gateway 2 access the gateway 2, the gateway 2 does not have excessive traffic and is cheaper than the ISP terminal. Accordingly, although a user uses the same service, a provider can provide the service at a low cost when using the gateway 2 and thus can fix a rate lower than the normal rate applied when the ISP terminal is used.

However, when the gateway authorizer 28 authorizes the ISP terminal to perform a certain function for the node 3, the node accounting unit 29 charges the node 3 the normal rate.

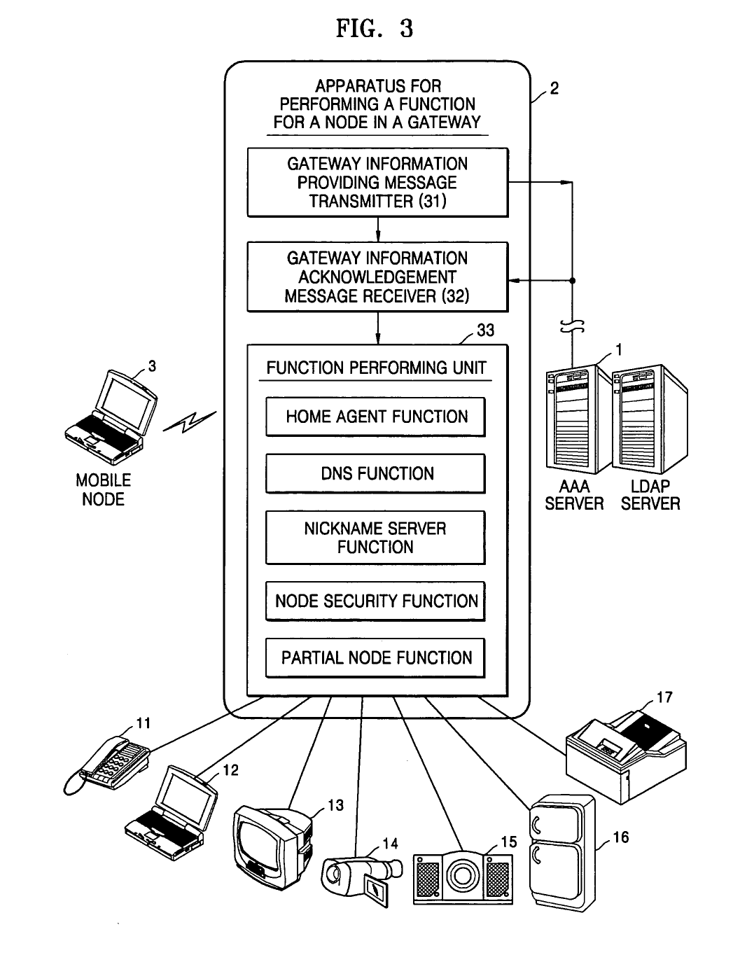

FIG. 3 is a diagram of an apparatus for performing a function for a node in a gateway consistent with an embodiment of the present invention. The apparatus for performing a function for a node in a gateway includes a gateway information providing message transmitter 31, a gateway information acknowledgement message receiver 32, and a function performing unit 33. This apparatus is installed in the gateway 2.

The gateway information providing message transmitter 31 transmits a gateway information providing message including information on each of the nodes 3 and 11 through 17 managed by the gateway 2 and information indicating a function performed by the gateway 2 for each of the nodes 3 and 11 through 17 to the AAA server 1. The gateway information providing message includes a field in which a network prefix of the gateway 2 is recorded, a field in which a MAC address of each of the nodes 3 and 11 through 17 is recorded, and a field in which a value indicating a function performed by the gateway 2 is recorded.

The gateway information acknowledgement message receiver 32 receives a gateway information acknowledgement message from the AAA server 1 having received the gateway information providing message transmitted from the gateway information providing message transmitter 31. The gateway information acknowledgement message indicates that the information on each of the nodes 3 and 11 through 17 managed by the gateway 2 and the information indicating a function performed by the gateway 2 for each of the nodes 3 and 11 through 17 have been confirmed. When the gateway 2 receives the gateway information acknowledgement message from the AAA server 1, the gateway 2 is informed that the AAA server 1 has received the gateway information providing message and that the AAA server 1 has authorized the gateway 2 to perform a certain function according to the information included in the gateway information providing message.

When the gateway information acknowledgement message receiver 32 receives the gateway information acknowledgement message, the function performing unit 33 performs the function for each of the nodes 3 and 11 through 17. The function may be any one of a home agent function of managing a mobile node, a DNS function of converting a node's domain name into an IP address, a nickname server function of converting a node's nickname into an IP address, a node security function, and a partial node function. Alternatively, the function may include all of the home agent function, the DNS function, the nickname server function, the node security function, and the partial node function. In other words, the home agent function, the DNS function, the nickname server function, the node security function, and the partial node function which are performed by a conventional ISP terminal can be performed by a home network equipment, i.e., a gateway, so that concentration of excessive traffic on the ISP terminal can be prevented. As such, a load on the ISP terminal can be distributed to home network equipments.

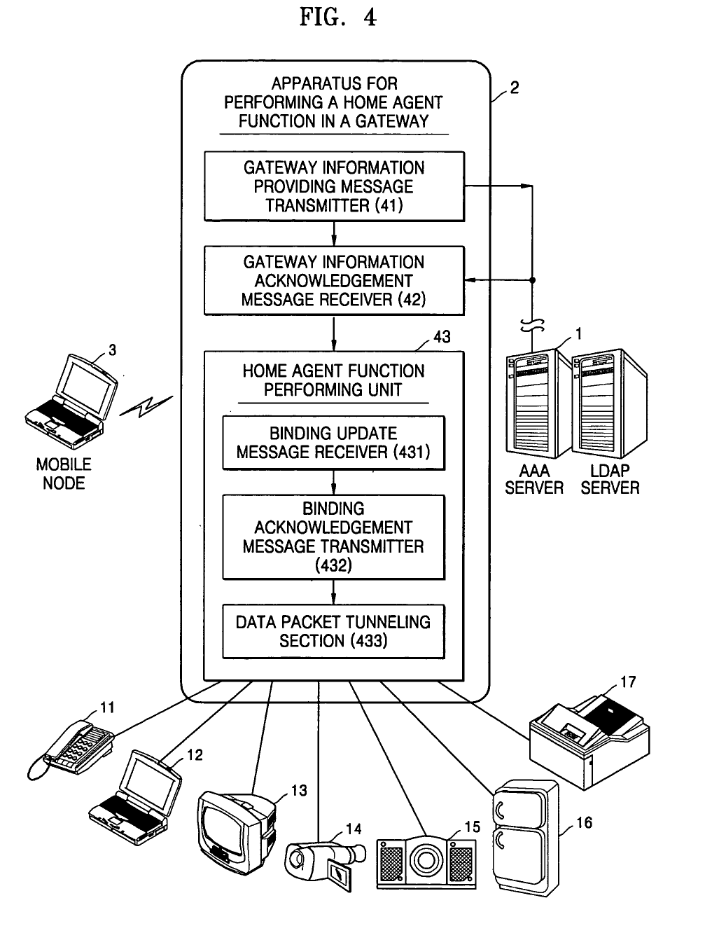

FIG. 4 is a diagram of an apparatus for performing a home agent function in a gateway consistent with an embodiment of the present invention. Referring to FIG. 4, the apparatus for performing a home agent function in a gateway includes a gateway information providing message transmitter 41, a gateway information acknowledgement message receiver 42, and a home agent function performing unit 43. The apparatus is installed in the gateway 2.

The gateway information providing message transmitter 41 transmits a gateway information providing message to the AAA server 1. The gateway information providing message includes information on the mobile node 3 managed by the gateway 2 and information indicating whether a home agent function is performed by the gateway 2 for the mobile node 3. For example, when a value of “1” indicates the home agent function, the gateway information providing message includes a field in which a network prefix of the gateway 2 is recorded, a field in which a MAC address of the mobile node 3 is recorded, and a field in which a value of “1” is recorded.

The gateway information acknowledgement message receiver 42 receives a gateway information acknowledgement message from the AAA server 1 having received the gateway information providing message transmitted from the gateway information providing message transmitter 31. The gateway information acknowledgement message indicates that the information on the mobile node 3 managed by the gateway 2 and the information indicating whether the home agent function is performed by the gateway 2 for the mobile node 3 have been confirmed. When the gateway 2 receives the gateway information acknowledgement message from the AAA server 1, the gateway 2 is informed that the AAA server 1 has received the gateway information providing message and that the AAA server 1 has authorized the gateway 2 to perform the home agent function according to the information included in the gateway information providing message.

When the gateway information acknowledgement message receiver 42 receives the gateway information acknowledgement message, that is, when the apparatus recognizes that the gateway 2 is authorized to perform the home agent function, the home agent function performing unit 43 performs the home agent function for the mobile node 3 on the external network among the nodes 3 and 11 through 17 managed by the gateway 2.

The home agent function performing unit 43 includes a binding update message receiver 431, a binding acknowledgement message transmitter 432, and a data packet tunneling section 433.

The binding update message receiver 431 receives a binding update message from the mobile node 3. The binding update message includes a temporary IP address of the mobile node 3 on the external network. When the binding update message receiver 431 receives the binding update message, the binding acknowledgement message transmitter 432 transmits a binding acknowledgement message to the mobile node 3. The binding acknowledgement message indicates that the temporary IP address (i.e., a care of address (CoA)) has been confirmed. The data packet tunneling section 433 intercepts a data packet, which has the IP address of the mobile node 3 as a destination IP address, and tunnels the intercepted data packet to the temporary IP address.

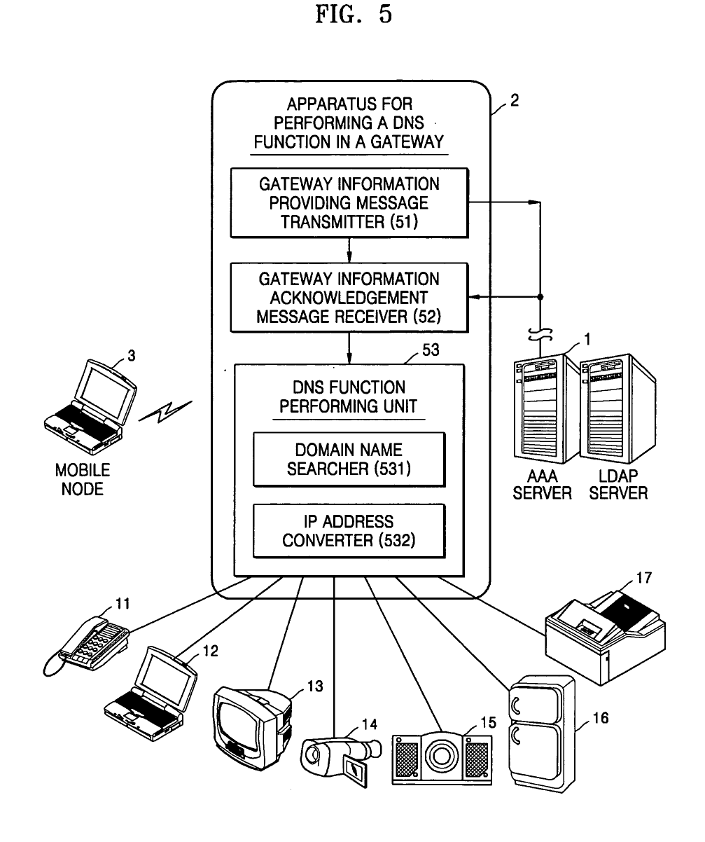

FIG. 5 is a diagram of an apparatus for performing a DNS function in a gateway consistent with an embodiment of the present invention. Referring to FIG. 5, the apparatus for performing a DNS function in a gateway includes a gateway information providing message transmitter 51, a gateway information acknowledgement message receiver 52, and a DNS function performing unit 53. The apparatus is installed in the gateway 2.

The gateway information providing message transmitter 51 transmits a gateway information providing message to the AAA server 1. The gateway information providing message includes information on each of the nodes 3 and 11 through 17 managed by the gateway 2 and information indicating whether a DNS function is performed by the gateway 2 for each of the nodes 3 and 11 through 17. For example, when a value of “2” indicates the DNS function, the gateway information providing message includes a field in which a network prefix of the gateway 2 is recorded, a field in which a MAC address of each of the nodes 3 and 11 through 17 is recorded, and a field in which a value of “2” is recorded.

The gateway information acknowledgement message receiver 52 receives a gateway information acknowledgement message from the AAA server 1 having received the gateway information providing message transmitted from the gateway information providing message transmitter 51. The gateway information acknowledgement message indicates that the information on each of the nodes 3 and 11 through 17 managed by the gateway 2 and the information indicating whether the DNS function is performed by the gateway 2 for each of the nodes 3 and 11 through 17 have been confirmed. When the gateway 2 receives the gateway information acknowledgement message from the AAA server 1, the gateway 2 is informed that the AAA server 1 has received the gateway information providing message and that the AAA server 1 has authorized the gateway 2 to perform the DNS function according to the information included in the gateway information providing message.

When the gateway information acknowledgement message receiver 52 receives the gateway information acknowledgement message, that is, when the apparatus recognizes that the gateway 2 is authorized to perform the DNS function, the DNS function performing unit 53 performs the DNS function for each of the nodes 3 and 11 through 17 managed by the gateway 2.

The DNS function performing unit 53 includes a domain name searcher 531 and an IP address converter 532. The domain name searcher 531 searches an IP address database within the gateway 2 or an IP address database of a DNS outside the gateway 2 for a domain name of each of the nodes 3 and 11 through 17. Here, the gateway 2 usually performs only a DNS relay function that searches the IP address database in the external DNS. When the domain name searcher 531 finds the domain name, the IP address converter 532 converts the domain name into an IP address based on the IP address database within the gateway 2 or the external DNS.

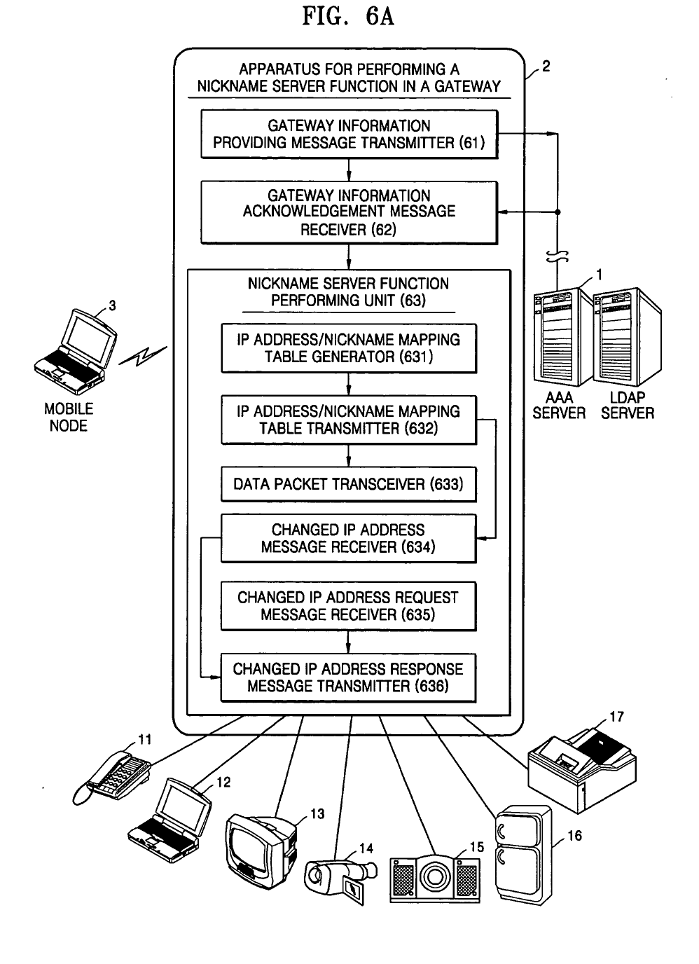

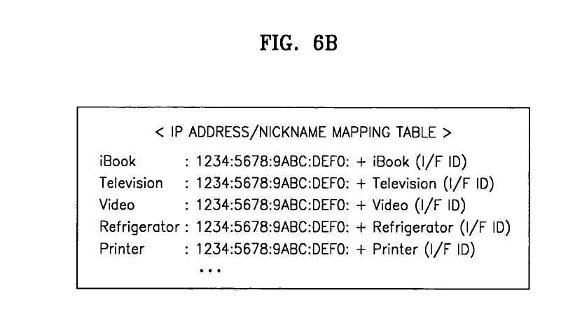

FIG. 6A is a diagram of an apparatus for performing a nickname server function in a gateway consistent with an embodiment of the present invention. FIG. 6B shows an example of an IP address/nickname mapping table used in the present invention.

Referring to FIG. 6A, the apparatus for performing a nickname server function in a gateway includes a gateway information providing message transmitter 61, a gateway information acknowledgement message receiver 62, and a nickname server function performing unit 63. The apparatus is installed in the gateway 2.

The gateway information providing message transmitter 61 transmits a gateway information providing message to the AAA server 1. The gateway information providing message includes information on each of the nodes 3 and 11 through 17 managed by the gateway 2 and information indicating whether a nickname server function is performed by the gateway 2 for each of the nodes 3 and 11 through 17. For example, when a value of “3” indicates the nickname server function, the gateway information providing message includes a field in which a network prefix of the gateway 2 is recorded, a field in which a MAC address of each of the nodes 3 and 11 through 17 is recorded, and a field in which a value of “3” is recorded.

The gateway information acknowledgement message receiver 62 receives a gateway information acknowledgement message from the AAA server 1 having received the gateway information providing message transmitted from the gateway information providing message transmitter 61. The gateway information acknowledgement message indicates that the information on each of the nodes 3 and 11 through 17 managed by the gateway 2 and the information indicating whether the nickname server function is performed by the gateway 2 for each of the nodes 3 and 11 through 17 have been confirmed. When the gateway 2 receives the gateway information acknowledgement message from the AAA server 1, the gateway 2 is informed that the AAA server 1 has received the gateway information providing message and that the AAA server 1 has authorized the gateway 2 to perform the nickname server function according to the information included in the gateway information providing message.

When the gateway information acknowledgement message receiver 62 receives the gateway information acknowledgement message, that is, when the apparatus recognizes that the gateway 2 is authorized to perform the nickname server function, the nickname server function performing unit 63 performs the nickname server function for each of the nodes 3 and 11 through 17 managed by the gateway 2.

The nickname server function performing unit 63 includes an IP address/nickname mapping table generator 631, an IP address/nickname mapping table transmitter 632, a data packet transceiver 633, a changed IP address receiver 634, a changed IP address request message receiver 635, and a changed IP address response message transmitter 636.

The IP address/nickname mapping table generator 631 allocates a nickname to an IP address of each of the nodes 3 and 11 through 17 managed by the gateway 2 in one-to-one correspondence and generates an IP address/nickname mapping table. Referring to FIG. 6B, which shows an example of the IP address/nickname mapping table, an IP address of the node 12 is composed of 1234:5678:9ABC:DEFO:+ an interface (I/F) ID. The IP address of the node 12 is allocated a nickname “iBook”. Similarly, a nickname “Television” is allocated to an IP address of the node 13, a nickname “Video” is allocated to an IP address of the node 14, a nickname “Refrigerator” is allocated to an IP address of the node 16, and a nickname “Printer” is allocated to an IP address of the node 17.

The IP address/nickname mapping table transmitter 632 transmits the IP address/nickname mapping table generated by the IP address/nickname mapping table generator 631 to each of the nodes 3 and 11 through 17 managed by the gateway 2. After all of the nodes 3 and 11 through 17 managed by the gateway 2 receive the IP address/nickname mapping table, instead of the long IP addresses as shown in FIG. 6B, a short nickname corresponding to an IP address is used.

The data packet transceiver 633 performs transmission and reception of a data packet between the nodes 3 and 11 through 17, which have received the IP address/nickname mapping table, using a nickname as a source index and a destination index. For example, when a source is the node 12 and a destination is the node 17, the data packet transceiver 633 records “iBook” and “Printer” instead of IP addresses in a source address field and a destination address field, respectively, of a data packet header. Since a nickname has a less amount of data than an IP address, a data load on the gateway 2 during transmission and reception is reduced. In addition, since a nickname is a sort of domain name available only within a network, a load on an existing DNS is also reduced. Furthermore, unlike a domain name, a nickname is available only within a network, and thus the nickname is not known outside. Accordingly, security for equipments on the network is enhanced.

When the IP address of a node having received the IP address/nickname mapping table is changed, the changed IP address receiver 634 receives the changed IP address from the node. The IP address of a node having received the IP address/nickname mapping table happens to change due to various causes. In this time, the node having the changed IP address transmits the changed IP address to a gateway managing the node, and the gateway receives the changed IP address.

The changed IP address request message receiver 635 receives a changed IP address request message including a nickname of the node having the changed IP address from nodes managed by the gateway other than the node having the changed IP address. When a data packet is transmitted to the node having a changed IP address, using an old IP address of the node, transmission fails. At this time, a node transmitting the data packet transmits a changed IP address request message to the gateway.

When the changed IP address request message receiver 635 receives the changed IP address request message, the changed IP address response message transmitter 636 transmits a changed IP address response message including the changed IP address received by the changed IP address receiver 634 to the nodes other than the node having the changed IP address. Then, the node failing in transmitting the data packet receives the changed IP address response message and re-transmits the data packet using the changed IP address.

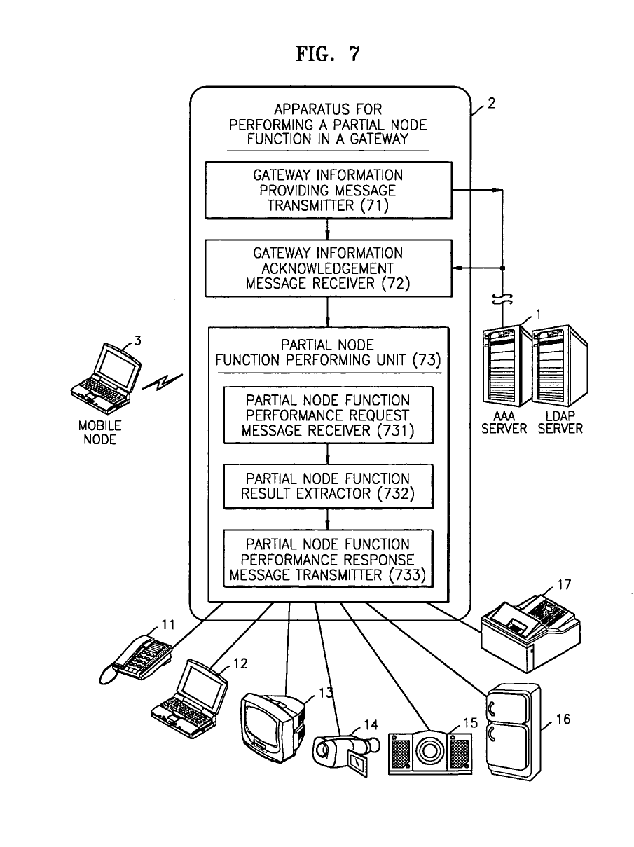

FIG. 7 is a diagram of an apparatus for performing a partial node function in a gateway consistent with an embodiment of the present invention. The apparatus for performing a partial node function in a gateway includes a gateway information providing message transmitter 71, a gateway information acknowledgement message receiver 72, and a partial node function performing unit 73. The apparatus is installed in the gateway 2.

The gateway information providing message transmitter 71 transmits a gateway information providing message to the AAA server 1. The gateway information providing message includes information on each of the nodes 3 and 11 through 17 managed by the gateway 2 and information indicating whether a partial node function is performed by the gateway 2 for each of the nodes 3 and 11 through 17. For example, when a value of “5” indicates the partial node function, the gateway information providing message includes a field in which a network prefix of the gateway 2 is recorded, a field in which a MAC address of each of the nodes 3 and 11 through 17 is recorded, and a field in which a value of “5” is recorded.

The gateway information acknowledgement message receiver 72 receives a gateway information acknowledgement message from the AAA server 1 having received the gateway information providing message transmitted from the gateway information providing message transmitter 71. The gateway information acknowledgement message indicates that the information on each of the nodes 3 and 11 through 17 managed by the gateway 2 and the information indicating whether the partial node function is performed by the gateway 2 for each of the nodes 3 and 11 through 17 have been confirmed. When the gateway 2 receives the gateway information acknowledgement message from the AAA server 1, the gateway 2 is informed that the AAA server 1 has received the gateway information providing message and that the AAA server 1 has authorized the gateway 2 to perform the partial node function according to the information included in the gateway information providing message.

When the gateway information acknowledgement message receiver 72 receives the gateway information acknowledgement message, that is, when the apparatus recognizes that the gateway 2 is authorized to perform the partial node function, the partial node function performing unit 73 performs the partial node function for each of the nodes 3 and 11 through 17 managed by the gateway 2.

The partial node function performing unit 73 includes a partial node function performance request message receiver 731, a partial node function result extractor 732, and a partial node function performance response message transmitter 733.

The partial node function performance request message receiver 731 receives a partial node function performance request message, which requests to perform a partial node function requiring more resources than other functions of a node, from the node. Usually, a partial function of the mobile node 3 is performed because a small and lightweight terminal is used at the mobile node 3. Due to limitations in volume and weight, it is difficult to install a high-speed processor or large-capacity of memory on a small and light-weight terminal. Accordingly, such a small and light-weight mobile terminal cannot perform a function requiring a lot of resources. Even if it can perform the function, the function cannot be smoothly performed. Therefore, the gateway 2 is used to perform the function in place of the mobile node 3.

When the partial node function performance request message receiver 731 receives the partial node function performance request message, the partial node function result extractor 732 performs a partial node function and extracts the result of performing the partial node function. Since the mobile node 3 needs only the result of performing the partial node function, the result of performing the partial node function is extracted and transmitted to the mobile node 3.

The partial node function performance response message transmitter 733 transmits a partial node function performance response message to the mobile node 3. The partial node function performance response message includes the result of performing the partial node function extracted by the partial node function result extractor 732. Then, the mobile node 3 receives the partial node function performance response message and performs a desired operation using the result of performing the partial node function.

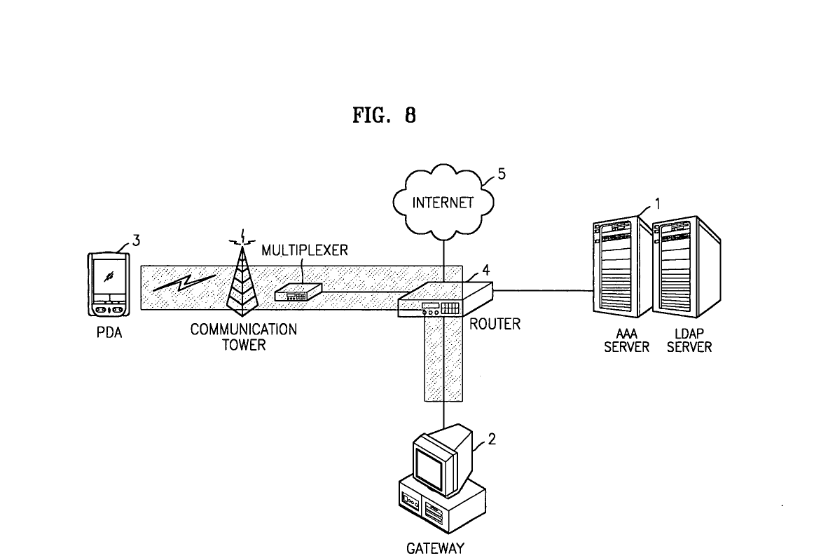

FIG. 8 illustrates a private security function consistent with an embodiment of the present invention. When the gateway 2 performs the home agent function, the DNS function, etc., which are performed by a conventional ISP terminal, i.e., the AAA server 1, the AAA server 1 does not engage in performing these functions afterwards. Since a large number of nodes access the AAA server 1, the AAA server 1 is vulnerable in terms of security. In the present invention, as shown in FIG. 8, the mobile node 3, for example, a PDA, communicates with the gateway 2 via the router 4 without using the AAA server 1. Accordingly, security between the gateway 2 installed at home and the mobile node 3 is enhanced. In other words, private security is enhanced. In addition, since an IP address of a node is not known outside when the gateway 2 performs the nickname server function, private security is further enhanced.

Moreover, conventional ISP terminals provide a private security function, but they cannot provide specialized security functions because they must follow an international communication security protocol, i.e., an IP security protocol (IPSEC). However, consistent with the present invention, since the gateway 2 communicates with the mobile node 3 without using the ISP terminal, a specialized security function such as fingerprint recognition or voice recognition can be used in a path between the gateway 2 and the mobile node 3. In particular, private security can be further enhanced by using different security techniques for different gateways.

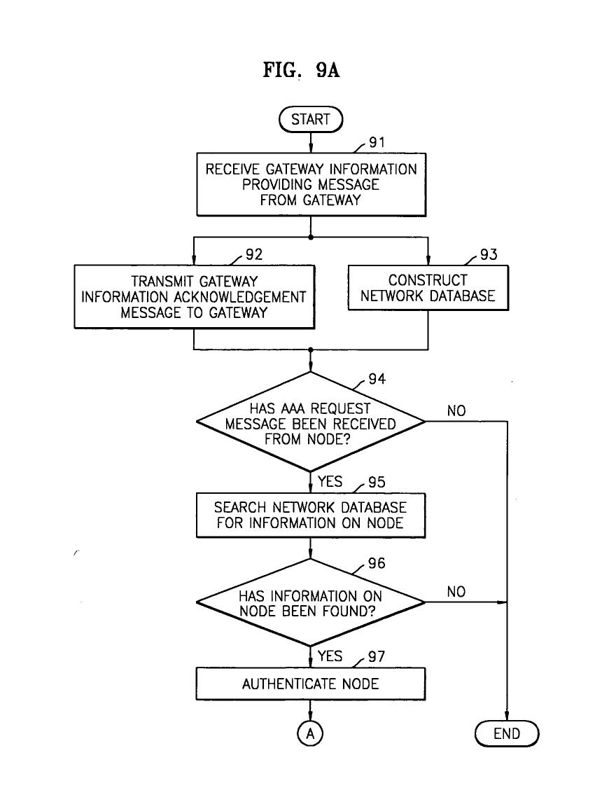

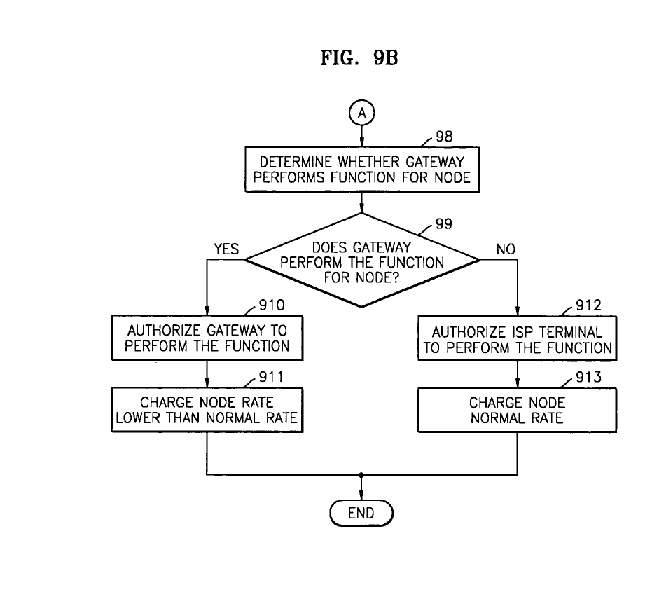

FIGS. 9A and 9B are flowcharts of a method of authorizing a gateway consistent with an embodiment of the present invention. Referring to FIGS. 9A and 9B, a gateway information providing message including information on each node managed by a gateway on a predetermined network and information indicating a function performed by the gateway for the node is received from the gateway (91). Next, a gateway information acknowledgement message including information indicating that the gateway information providing message has been received is transmitted to the gateway (92). A network database including the information on the node managed by the gateway and the information indicating the function performed by the gateway for the node, which are included in the gateway information providing message, is constructed (93). The function may be any one of a home agent function of managing a mobile node, a DNS function of converting a node's domain name into an IP address, a nickname server function of converting a node's nickname into an IP address, a node security function, and a partial node function. Alternatively, the function may include the home agent function, the DNS function, the nickname server function, the node security function, and the partial node function.

Next, it is determined whether an AAA request message including information on the node has been received from the node (94). When it is determined that the AAA request message has been received, the network database is searched for the information on the node (95). Next, it is determined whether the information on the node has been found in the network database (96). When it is determined that the information on the node has been found, the node having transmitted the AAA request message is authenticated (97).

Next, it is determined whether the gateway can perform the function for the node based on the network database (98). When it is determined that the gateway can perform the function for the node (99), the gateway is authorized to perform the function for the node (910). However, when it is determined that the gateway cannot perform the function for the node (99), an ISP terminal is authorized to perform the function for the node (912). When the gateway is authorized to perform the function for the node, the node is charged a rate lower than a normal rate (911). When the ISP terminal is authorized to perform the function for the node, the node is charged the normal rate (913).

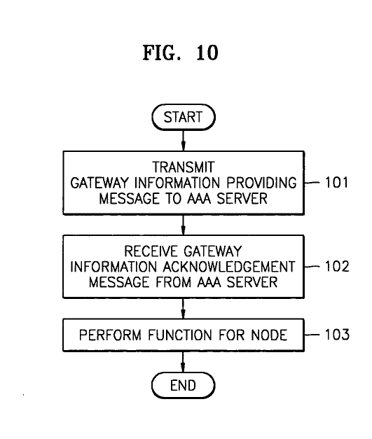

FIG. 10 is a flowchart of a method by which a gateway performs a function for a node, consistent with an embodiment of the present invention. Referring to FIG. 10, a gateway information providing message including information on each node managed by a gateway on a predetermined network and information indicating a function performed by the gateway for the node is transmitted to an AAA server (101). Next, a gateway information acknowledgement message indicating that the information on the node managed by the gateway and the information indicating the function performed by the gateway for the node have been confirmed is received from the AAA server (102). Next, the gateway performs the function for the node (103).

The function may be any one of a home agent function of managing a mobile node, a DNS function of converting a node's domain name into an IP address, a nickname server function of converting a node's nickname into an IP address, a node security function, and a partial node function. Alternatively, the function may include the home agent function, the DNS function, the nickname server function, the node security function, and the partial node function.

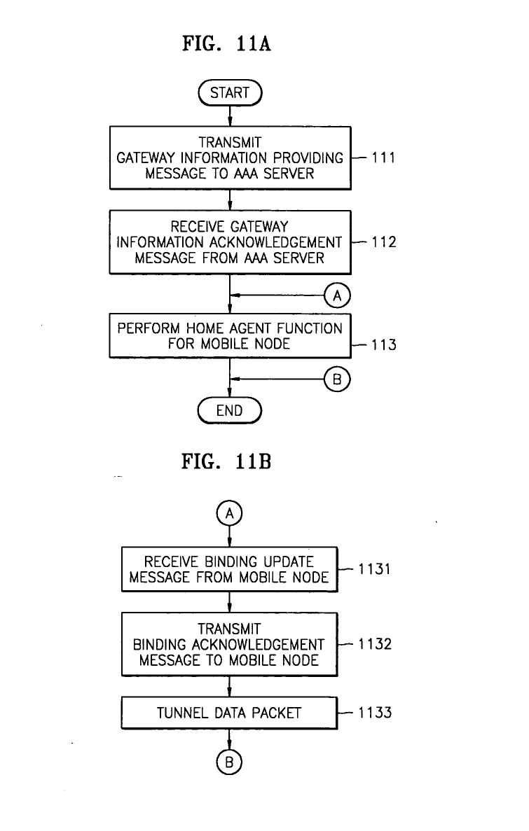

FIGS. 11A and 11B are flowcharts of a method by which a gateway performs a home agent function consistent with an embodiment of the present invention. Referring to FIG. 11A, a gateway information providing message including information on a mobile node managed by a gateway on a predetermined network and information indicating whether a home agent function is performed by the gateway for the mobile node is transmitted to an AAA server (111). Next, a gateway information acknowledgement message indicating that the information on the mobile node managed by the gateway and the information indicating whether the home agent function is performed by the gateway for the mobile node have been confirmed is received from the AAA server (112). Next, the gateway performs the home agent function for the mobile node (113).

Referring to FIG. 11B, step 113 shown in FIG. 11A includes the following steps. A binding update message including a temporary IP address of the mobile node on an external network is received from the mobile node (1131). Next, a binding acknowledgement message indicating that the temporary IP address of the mobile node has been confirmed is transmitted to the mobile node (1132). Next, a data packet, which is transmitted from a certain node and has the IP address of the mobile node as a destination IP address, is intercepted and tunneled to the temporary IP address of the mobile node (1133).

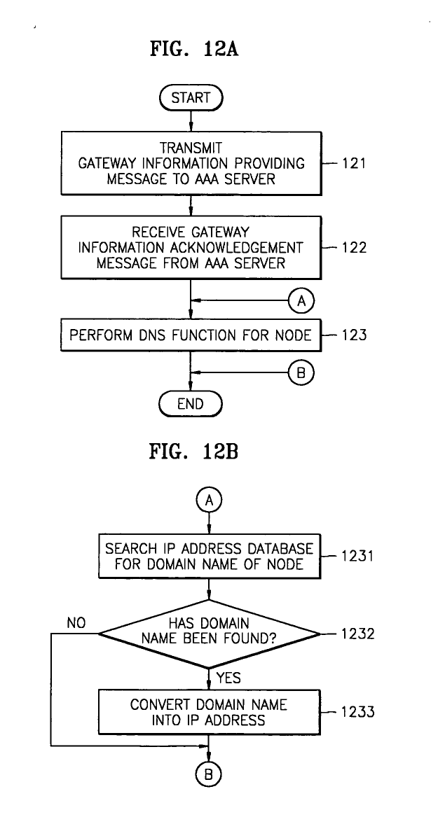

FIGS. 12A and 12B are flowcharts of a method by which a gateway performs a DNS function consistent with an embodiment of the present invention. Referring to FIG. 12A, a gateway information providing message including information on each node managed by a gateway on a predetermined network and information indicating whether a DNS function is performed by the gateway for the node is transmitted to an AAA server (121). Next, a gateway information acknowledgement message indicating that the information on the node managed by the gateway and the information indicating whether the DNS function is performed by the gateway for the node have been confirmed is received from the AAA server (122). Next, the gateway performs the DNS function for the node (123).

Referring to FIG. 12B, step 123 shown in FIG. 12A includes the following steps. An IP address database within the gateway or an external DNS is searched for a domain name of the node (1231). When the domain name of the node has been found (1232), the domain name is converted into an IP address based on the IP address database within the gateway or the external DNS (1233).

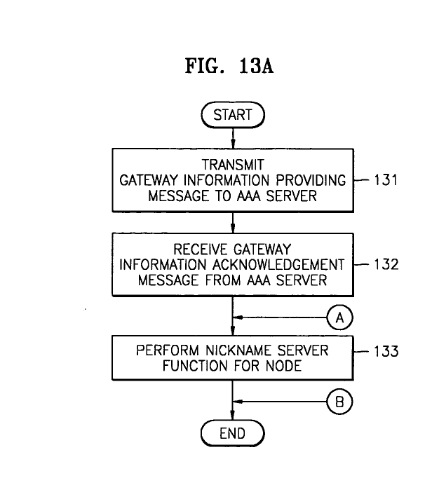

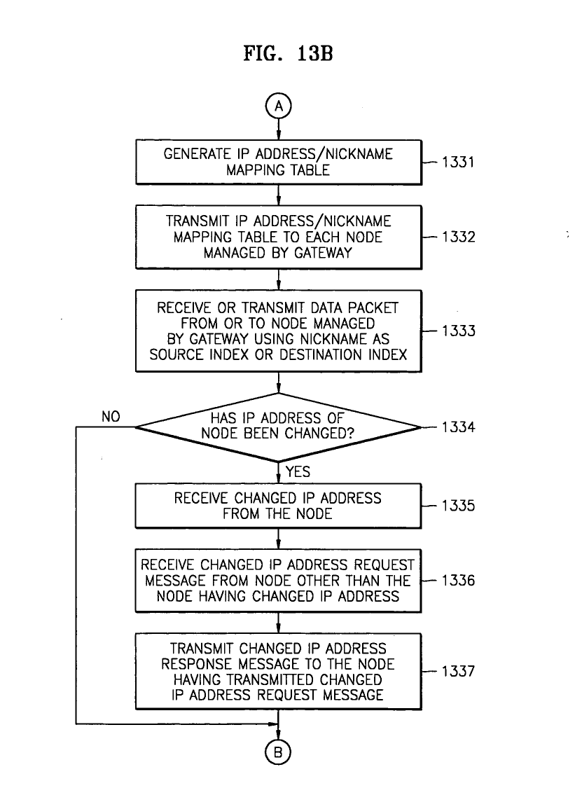

FIGS. 13A and 13B are flowcharts of a method by which a gateway performs a nickname server function consistent with an embodiment of the present invention. Referring to FIG. 13A, a gateway information providing message including information on each node managed by a gateway on a predetermined network and information indicating whether a nickname server function is performed by the gateway for the node is transmitted to an AAA server (131). Next, a gateway information acknowledgement message indicating that the information on the node managed by the gateway and the information indicating whether the nickname server function is performed by the gateway for the node have been confirmed is received from the AAA server (132). Next, the gateway performs the nickname server function for the node (133).

Referring to FIG. 13B, step 133 shown in FIG. 13A includes the following steps. A nickname is allocated to an IP address of each node managed by the gateway in one-to-one correspondence to generate an IP address/nickname mapping table (1331). Next, the IP address/nickname mapping table is transmitted to each node managed by the gateway (1332). Next, a data packet is received from or transmitted to a node having received the IP address/nickname mapping table using a nickname as a source index or a destination index (1333).

When it is determined that an IP address of a node having received the IP address/nickname mapping table has been changed (1334), the changed IP address is received from the node (1335). Next, a changed IP address request message including a nickname of the node having the changed IP address is received from a predetermined node managed by the gateway except the node having the changed IP address (1336). Next, a changed IP address response message including the changed IP address is transmitted to the predetermined node except the node having the changed IP address (1337).

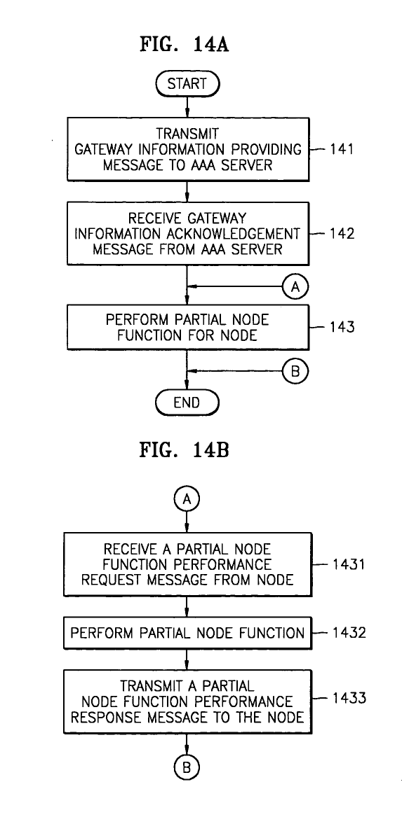

FIGS. 14A and 14B are flowcharts of a method by which a gateway performs a partial node function consistent with an embodiment of the present invention. Referring to FIG. 14A, a gateway information providing message including information on each node managed by a gateway on a predetermined network and information indicating whether a partial node function is performed by the gateway for the node is transmitted to an AAA server (141). Next, a gateway information acknowledgement message indicating that the information on the node managed by the gateway and the information indicating whether the partial node function is performed by the gateway for the node have been confirmed is received from the AAA server (142). Next, the gateway performs the partial node function for the node (143).

Referring to FIG. 14B, step 143 shown in FIG. 14A includes the following steps. A partial node function performance request message requesting to perform a partial node function requiring more resources than other node functions is received from a node (1431). Next, the partial node function is performed and the result of performing the partial node function is extracted (1432). Next, a partial node function performance response message including the result of performing the partial node function is transmitted to the node (1433).

The above-described exemplary embodiments of the present invention can be realized as programs, which can be executed in a universal digital computer through a computer readable recording medium. The computer readable recording medium may be a storage media, such as a magnetic storage medium (for example, a ROM, a floppy disc, or a hard disc), an optical readable medium (for example, a CD-ROM or DVD), or carrier waves (for example, transmitted through Internet).

Consistent with the present invention, a home network equipment, i.e., a gateway, can perform various functions, such as a home agent function, a DNS function, a nickname server function, a node security function, and a partial node function, performed by an ISP terminal so that excessive traffic is prevented from being concentrated on the ISP terminal. In other words, a load on the ISP terminal can be distributed to a plurality of home network equipments. In addition, since an inexpensive gateway not having much traffic is used instead of an expensive ISP terminal having much traffic, costs for providing services can be reduced.

Consistent with the present invention, since a gateway can communicate with a node without using an ISP terminal, a specialized security function such as fingerprint recognition or voice recognition can be used in a path between the gateway and the node. In particular, private security can be further enhanced by using different security techniques for different gateways. When a gateway performs a nickname server function, a data load on the gateway and a DNS during transmission and reception is reduced, and security for equipments on a network is enhanced.

When a gateway performs a function of a node and particularly a mobile node, the gateway smoothly performs a node function requiring a lot of resources and allows the node to use the result of performing the node function so that the node can freely perform various operations requiring a lot of resources regardless of its characteristics.

While this invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

1. An apparatus for authorizing a gateway, comprising:
a gateway function determiner, which determines whether a gateway on a predetermined network performs a particular function for a predetermined node based on a network database comprising information on each node managed by the gateway and information indicating a function performed by the gateway for the node; and
a gateway authorizer, which authorizes the gateway to perform the particular function for the predetermined node when the gateway function determiner determines that the gateway performs the particular function for the predetermined node.

2. The apparatus of claim 1, wherein the function is one selected from the group comprising a home agent function of managing a mobile node, a domain name server function of converting a node's domain name into an Internet protocol address, a nickname server function of converting a node's nickname into an Internet protocol address, a node security function, and a partial node function or comprises the home agent function, the domain name server function, the nickname server function, the node security function, and the partial node function.

3. The apparatus of claim 1, wherein when the gateway function determiner determines that the gateway does not perform the particular function for the predetermined node, the gateway authorizer authorizes an Internet service provider terminal to perform the particular function for the predetermined node.

4. The apparatus of claim 3, further comprising a node accounting unit, which charges the predetermined node a rate lower than a normal rate when the gateway authorizer authorizes the gateway to perform the particular function for the predetermined node.

5. The apparatus of claim 4, wherein the node accounting unit charges the predetermined node the normal rate when the gateway authorizer authorizes the Internet service provider terminal to perform the particular function for the predetermined node.

6. The apparatus of claim 3, further comprising:
a gateway information providing message receiver, which receives a gateway information providing message from the gateway, the gateway information providing message comprising the information on each node managed by the gateway and the information indicating a function performed by the gateway for the node;
a gateway information acknowledgement message transmitter, which transmits a gateway information acknowledgement message to the gateway when the gateway information providing message receiver receives the gateway information providing message, the gateway information acknowledgement message comprising information indicating that the gateway information providing message has been received;
a network database constructor, which constructs a network database comprising the information on each node managed by the gateway and the information indicating a function performed by the gateway for the node that are comprised in the gateway information providing message;
an authentication/authorization/accounting request message receiver, which receives an authentication/authorization/accounting request message comprising information on the predetermined node from the predetermined node;
a node information searcher, which when the authentication/authorization/accounting request message receiver receives the authentication/authorization/accounting request message, searches the network database for the information on the predetermined node comprised in the authentication/authorization/accounting request message; and
a node authenticator, which when the node information searcher has found the information on the predetermined node, authenticates the predetermined node having transmitted the authentication/authorization/accounting request message.

7. The apparatus of claim 6, further comprising a gateway function determiner which determines whether the gateway performs the particular function for the predetermined node authenticated by the node authenticator based on the network database constructed by the network database constructor, and
a gateway authorizer which authorizes the gateway to perform the particular function for the predetermined node authenticated by the node authenticator when the gateway function determiner determines that the gateway performs the particular function for the predetermined node.

8. The apparatus of claim 7, wherein the gateway authorizer authorizes the Internet service provider terminal to perform the particular function for the predetermined node authenticated by the node authenticator when the gateway function determiner determines that the gateway does not perform the particular function for the predetermined node.

9. An apparatus for performing a function for a node in a gateway, comprising:
a gateway information providing message transmitter, which transmits a gateway information providing message to an authentication/authorization/accounting server, the gateway information providing message comprising information on each node managed by the gateway on a predetermined network and information indicating a function performed by the gateway for the node;
a gateway information acknowledgement message receiver, which receives a gateway information acknowledgement message from the authentication/authorization/accounting server, the gateway information acknowledgement message indicating that the information on each node managed by the gateway and the information indicating a function performed by the gateway for the node has been confirmed; and
a function performing unit, which performs the function for a predetermined node when the gateway information acknowledgement message receiver receives the gateway information acknowledgement message.

10. The apparatus of claim 9, wherein the function is one selected from the group comprising a home agent function of managing a mobile node, a domain name server function of converting a node's domain name into an Internet protocol address, a nickname server function of converting a node's nickname into an Internet protocol address, a node security function, and a partial node function or comprises the home agent function, the domain name server function, the nickname server function, the node security function, and the partial node function.

11. An apparatus for performing a home agent function for a node in a gateway, comprising:
a gateway information providing message transmitter, which transmits a gateway information providing message to an authentication/authorization/accounting server, the gateway information providing message comprising information on each mobile node managed by the gateway on a predetermined network and information indicating whether the home agent function is performed by the gateway for the mobile node;
a gateway information acknowledgement message receiver, which receives a gateway information acknowledgement message from the authentication/authorization/accounting server, the gateway information acknowledgement message indicating that the information on each mobile node managed by the gateway and the information indicating whether the home agent function is performed by the gateway for the mobile node has been confirmed; and
a home agent function performing unit, which performs the home agent function for a predetermined mobile node when the gateway information acknowledgement message receiver receives the gateway information acknowledgement message.

12. The apparatus of claim 11, wherein the home agent function performing unit comprises:
a binding update message receiver, which receives a binding update message from the predetermined mobile node, the binding update message comprising a temporary Internet protocol address of the mobile node on an external network;
a binding acknowledgement message transmitter, which transmits a binding acknowledgement message to the predetermined mobile node when the binding update message receiver receives the binding update message, the binding acknowledgement message indicating that the temporary Internet protocol address of the predetermined mobile node has been confirmed; and
a data packet tunneling section, which intercepts a data packet having the Internet protocol address of the predetermined mobile node on the predetermined network as a destination Internet protocol address and tunnels the intercepted data packet to the temporary Internet protocol address of the predetermined mobile node.

13. An apparatus for performing a domain name server function for a node in a gateway, comprising:
a gateway information providing message transmitter, which transmits a gateway information providing message to an authentication/authorization/accounting server, the gateway information providing message comprising information on each node managed by the gateway on a predetermined network and information indicating whether the domain name server function is performed by the gateway for the node;
a gateway information acknowledgement message receiver, which receives a gateway information acknowledgement message from the authentication/authorization/accounting server, the gateway information acknowledgement message indicating that the information on each node managed by the gateway and the information indicating whether the domain name server function is performed by the gateway for the node has been confirmed; and
a domain name server function performing unit, which performs the domain name server function for a predetermined node when the gateway information acknowledgement message receiver receives the gateway information acknowledgement message.

14. The apparatus of claim 13, wherein the domain name server function performing unit comprises:
a domain name searcher, which searches an Internet protocol address database within the gateway or an external domain name server for a domain name of the predetermined node; and
an Internet protocol address converter, which converts the domain name found by the domain name searcher into an Internet protocol address based on the Internet protocol address database within the gateway or the external domain name server.

15. An apparatus for performing a nickname server function for a node in a gateway, comprising:
a gateway information providing message transmitter, which transmits a gateway information providing message to an authentication/authorization/accounting server, the gateway information providing message comprising information on each node managed by the gateway on a predetermined network and information indicating whether a nickname server function is performed by the gateway for the node;
a gateway information acknowledgement message receiver, which receives a gateway information acknowledgement message from the authentication/authorization/accounting server, the gateway information acknowledgement message indicating that the information on each node managed by the gateway and the information indicating whether the nickname server function is performed by the gateway for the node has been confirmed; and
a nickname server function performing unit, which performs the nickname server function for a predetermined node when the gateway information acknowledgement message receiver receives the gateway information acknowledgement message.

16. The apparatus of claim 15, wherein the nickname server function performing unit comprises:
an Internet protocol address/nickname mapping table generator, which generates an Internet protocol address/nickname mapping table by allocating a nickname to an Internet protocol address of each node managed by the gateway in one-to-one correspondence;
an Internet protocol address/nickname mapping table transmitter, which transmits the Internet protocol address/nickname mapping table to each node managed by the gateway; and
a data packet transceiver, which receives or transmits a data packet from or to a node having received the Internet protocol address/nickname mapping table using the nickname as a source index or a destination index.

17. The apparatus of claim 16, wherein the nickname server function performing unit further comprises:
a changed Internet protocol address receiver, which when an Internet protocol address of a node having received the Internet protocol address/nickname mapping table is changed, receiving the changed Internet protocol address from the node;
a changed Internet protocol address request message receiver, which receives a changed Internet protocol address request message comprising a nickname of the node having the changed Internet protocol address from a predetermined node managed by the gateway except the node having the changed Internet protocol address; and
a changed Internet protocol address request message transmitter, which transmits a changed Internet protocol address response message comprising the changed Internet protocol address to the predetermined node when the changed Internet protocol address request message receiver receives the changed Internet protocol address request message.

18. An apparatus for performing a partial node function for a node in a gateway, comprising:
a gateway information providing message transmitter, which transmits a gateway information providing message to an authentication/authorization/accounting server, the gateway information providing message comprising information on each node managed by the gateway on a predetermined network and information indicating whether the partial node function is performed by the gateway for the node;
a gateway information acknowledgement message receiver, which receives a gateway information acknowledgement message from the authentication/authorization/accounting server, the gateway information acknowledgement message indicating that the information on each node managed by the gateway and the information indicating whether the partial node function is performed by the gateway for the node has been confirmed; and
a partial node function performing unit, which performs the partial node function for a predetermined node when the gateway information acknowledgement message receiver receives the gateway information acknowledgement message.

19. The apparatus of claim 18, wherein the partial node function performing unit comprises:
a partial node function performance request message receiver, which receives a partial node function performance request message from the predetermined node, the partial node function performance request message requesting the gateway to perform a partial node function requiring more resources than other functions of the predetermined node;
a partial node function result extractor, which when the partial node function performance request message receiver receives the partial node function performance request message from the predetermined node, performs the partial node function and extracts a result of performing the partial node function; and
a partial node function performance response message transmitter, which transmits a partial node function performance response message comprising the result of performing the partial node function to the predetermined node.

20. A method of authorizing a gateway, comprising:
determining whether a gateway on a predetermined network performs a particular function for a predetermined node based on a network database comprising information on each node managed by the gateway and information indicating a function performed by the gateway for the node; and
authorizing the gateway to perform the particular function for the predetermined node when it is determined that the gateway performs the particular function for the predetermined node.

21. The method of claim 20, wherein the function is one selected from the group comprising a home agent function of managing a mobile node, a domain name server function of converting a node's domain name into an Internet protocol address, a nickname server function of converting a node's nickname into an Internet protocol address, a node security function, and a partial node function or comprises the home agent function, the domain name server function, the nickname server function, the node security function, and the partial node function.

22. The method of claim 21, wherein authorizing the gateway to perform the particular function for the predetermined node, comprises authorizing an Internet service provider terminal to perform the particular function for the predetermined node when it is determined that the gateway does not perform the particular function for the predetermined node.

23. The method of claim 22, further comprising charging the predetermined node a rate lower than a normal rate when the gateway is authorized to perform the particular function for the predetermined node.

24. The method of claim 23, wherein charging the predetermined node comprises charging the predetermined node the normal rate when the Internet service provider terminal is authorized to perform the particular function for the predetermined node.

25. The method of claim 24, further comprising:
receiving a gateway information providing message from the gateway, the gateway information providing message comprising the information on each node managed by the gateway and the information indicating a function performed by the gateway for the node;
transmitting a gateway information acknowledgement message to the gateway when the gateway information providing message is received, the gateway information acknowledgement message comprising information indicating that the gateway information providing message has been received;
constructing a network database comprising the information on each node managed by the gateway and the information indicating a function performed by the gateway for the node that are comprised in the gateway information providing message;
receiving an authentication/authorization/accounting request message comprising information on the predetermined node from the predetermined node;
searching the network database for the information on the predetermined node comprised in the authentication/authorization/accounting request message when the authentication/authorization/accounting request message is received; and
authenticating the predetermined node having transmitted the authentication/authorization/accounting request message when the information on the predetermined node has been found.

26. The method of claim 25, wherein determining whether a gateway on the predetermined network performs the particular function for the predetermined node based on a network database comprises determining whether the gateway performs the particular function for the authenticated predetermined node based on the network database, and
authorizing the gateway to perform the particular function for the predetermined node comprises authorizing the gateway to perform the particular function for the authenticated predetermined node when it is determined that the gateway performs the particular function for the authenticated predetermined node.

27. The method of claim 26, wherein authorizing the gateway to perform the particular function for the predetermined node comprises authorizing the Internet service provider terminal to perform the particular function for the authenticated predetermined node when it is determined that the gateway does not perform the particular function for the authenticated predetermined node.

28. A method of performing a function for a node in a gateway, comprising:
transmitting a gateway information providing message to an authentication/authorization/accounting server, the gateway information providing message comprising information on each node managed by the gateway on a predetermined network and information indicating a function performed by the gateway for the node;
receiving a gateway information acknowledgement message from the authentication/authorization/accounting server, the gateway information acknowledgement message indicating that the information on each node managed by the gateway and the information indicating a function performed by the gateway for the node has been confirmed; and
performing the function for a predetermined node when the gateway information acknowledgement message is received.

29. The method of claim 28, wherein the function is one selected from the group comprising a home agent function of managing a mobile node, a domain name server function of converting a node's domain name into an Internet protocol address, a nickname server function of converting a node's nickname into an Internet protocol address, a node security function, and a partial node function or comprises the home agent function, the domain name server function, the nickname server function, the node security function, and the partial node function.

30. A method of performing a home agent function for a node in a gateway, comprising:
transmitting a gateway information providing message to an authentication/authorization/accounting server, the gateway information providing message comprising information on each mobile node managed by the gateway on a predetermined network and information indicating whether the home agent function is performed by the gateway for the mobile node;
receiving a gateway information acknowledgement message from the authentication/authorization/accounting server, the gateway information acknowledgement message indicating that the information on each mobile node managed by the gateway and the information indicating whether the home agent function is performed by the gateway for the mobile node has been confirmed; and
performing the home agent function for a predetermined mobile node when the gateway information acknowledgement message is received.

31. The method of claim 30, wherein performing the home agent function for the predetermined mobile node when the gateway information acknoweldgement message is received comprises:
receiving a binding update message from the predetermined mobile node, the binding update message comprising a temporary Internet protocol address of the predetermined mobile node on an external network;
transmitting a binding acknowledgement message to the predetermined mobile node when the binding update message is received, the binding acknowledgement message indicating that the temporary Internet protocol address of the predetermined mobile node has been confirmed; and
intercepting a data packet having the an Internet protocol address of the predetermined mobile node on the predetermined network as a destination Internet protocol address and tunneling the intercepted data packet to the temporary Internet protocol address of the predetermined mobile node.

32. A method of performing a domain name server function for a node in a gateway, comprising:
transmitting a gateway information providing message to an authentication/authorization/accounting server, the gateway information providing message comprising information on each node managed by the gateway on a predetermined network and information indicating whether the domain name server function is performed by the gateway for the node;
receiving a gateway information acknowledgement message from the authentication/authorization/accounting server, the gateway information acknowledgement message indicating that the information on each node managed by the gateway and the information indicating whether the domain name server function is performed by the gateway for the node has been confirmed; and
performing the domain name server function for a predetermined node when the gateway information acknowledgement message is received.

33. The method of claim 32, wherein performing the domain name server function for a predetermined node when the gateway information acknowledgement message is received comprises:
searching an Internet protocol address database within the gateway or an external domain name server for a domain name of the predetermined node; and
converting the domain name into an Internet protocol address based on the Internet protocol address database within the gateway or the external domain name server when the domain name is found.

34. A method of performing a nickname server function for a node in a gateway, comprising:
transmitting a gateway information providing message to an authentication/authorization/accounting server, the gateway information providing message comprising information on each node managed by the gateway on a predetermined network and information indicating whether the nickname server function is performed by the gateway for the node;
receiving a gateway information acknowledgement message from the authentication/authorization/accounting server, the gateway information acknowledgement message indicating that the information on each node managed by the gateway and the information indicating whether the nickname server function is performed by the gateway for the node has been confirmed; and
performing the nickname server function for a predetermined node when the gateway information acknowledgement message is received.

35. The method of claim 34, wherein performing the nickname server function for the predetermined node when the gateway information acknowledgement message is received comprises:
generating an Internet protocol address/nickname mapping table by allocating a nickname to an Internet protocol address of each node managed by the gateway in one-to-one correspondence;
transmitting the Internet protocol address/nickname mapping table to each node managed by the gateway; and
receiving or transmitting a data packet from or to a node having received the Internet protocol address/nickname mapping table using the nickname as a source index or a destination index.

36. The method of claim 35, wherein performing the nickname server function for the predetermined node when the gateway information acknowledgement message is received further comprises:
receiving the changed Internet protocol address from the node when an Internet protocol address of a node having received the Internet protocol address/nickname mapping table is changed;
receiving a changed Internet protocol address request message comprising a nickname of the node having the changed Internet protocol address from a predetermined node managed by the gateway except the node having the changed Internet protocol address; and
transmitting a changed Internet protocol address response message comprising the changed Internet protocol address to the predetermined node when the changed Internet protocol address request message is received.

37. A method of performing a partial node function for a node in a gateway, comprising:
transmitting a gateway information providing message to an authentication/authorization/accounting server, the gateway information providing message comprising information on each node managed by the gateway on a predetermined network and information indicating whether the partial node function is performed by the gateway for the node;
receiving a gateway information acknowledgement message from the authentication/authorization/accounting server, the gateway information acknowledgement message indicating that the information on each node managed by the gateway and the information indicating whether the partial node function is performed by the gateway for the node has been confirmed; and
performing the partial node function for a predetermined node when the gateway information acknowledgement message is received.

38. The method of claim 37, wherein performing the partial node function for the predetermined node when the gateway information acknowledgement message is received comprises:
receiving a partial node function performance request message from the predetermined node, the partial node function performance request message requesting the gateway to perform a partial node function requiring more resources than other functions of the predetermined node;
performing the partial node function and extracting the result of performing the partial node function when the partial node function performance request message is received from the predetermined node; and
transmitting a partial node function performance response message comprising the result of performing the partial node function to the predetermined node.

39. A computer readable medium for storing a program for performing a method of authorizing a gateway, the method comprising:
determining whether a gateway on a predetermined network performs a particular function for a predetermined node based on a network database comprising information on each node managed by the gateway and information indicating a function performed by the gateway for the node; and
authorizing the gateway to perform the particular function for the predetermined node when it is determines that the gateway performs the particular function for the predetermined node.

40. A computer readable recording medium for storing a program for performing a method of performing a function for a node in a gateway, the method comprising:
transmitting a gateway information providing message to an authentication/authorization/accounting server, the gateway information providing message comprising information on each node managed by the gateway on a predetermined network and information indicating a function performed by the gateway for the node;
receiving a gateway information acknowledgement message from the authentication/authorization/accounting server, the gateway information acknowledgement message indicating that the information on each node managed by the gateway and the information indicating a function performed by the gateway for the node has been confirmed; and
performing the function for a predetermined node when the gateway information acknowledgement message is received.

41. A computer readable recording medium for storing a program for performing a method of performing a home agent function for a node in a gateway, the method comprising:
transmitting a gateway information providing message to an authentication/authorization/accounting server, the gateway information providing message comprising information on each mobile node managed by the gateway on a predetermined network and information indicating whether the home agent function is performed by the gateway for the mobile node;
receiving a gateway information acknowledgement message from the authentication/authorization/accounting server, the gateway information acknowledgement message indicating that the information on each mobile node managed by the gateway and the information indicating whether the home agent function is performed by the gateway for the mobile node has been confirmed; and
performing the home agent function for a predetermined mobile node when the gateway information acknowledgement message is received.

42. A computer readable recording medium for storing a program for performing a method of performing a domain name server function for a node in a gateway, the method comprising:
transmitting a gateway information providing message to an authentication/authorization/accounting server, the gateway information providing message comprising information on each node managed by the gateway on a predetermined network and information indicating whether the domain name server function is performed by the gateway for the node;
receiving a gateway information acknowledgement message from the authentication/authorization/accounting server, the gateway information acknowledgement message indicating that the information on each node managed by the gateway and the information indicating whether the domain name server function is performed by the gateway for the node has been confirmed; and
performing the domain name server function for a predetermined node when the gateway information acknowledgement message is received.

43. A computer readable recording medium for storing a program for performing a method of performing a nickname server function for a node in a gateway, the method comprising:
transmitting a gateway information providing message to an authentication/authorization/accounting server, the gateway information providing message comprising information on each node managed by the gateway on a predetermined network and information indicating whether the nickname server function is performed by the gateway for the node;
receiving a gateway information acknowledgement message from the authentication/authorization/accounting server, the gateway information acknowledgement message indicating that the information on each node managed by the gateway and the information indicating whether the nickname server function is performed by the gateway for the node has been confirmed; and
performing the nickname server function for a predetermined node when the gateway information acknowledgement message is received.

44. A computer readable recording medium for storing a program for performing a method of performing a partial node function for a node in a gateway, the method comprising:
transmitting a gateway information providing message to an authentication/authorization/accounting server, the gateway information providing message comprising information on each node managed by the gateway on a predetermined network and information indicating whether the partial node function is performed by the gateway for the node;
receiving a gateway information acknowledgement message from the authentication/authorization/accounting server, the gateway information acknowledgement message indicating that the information on each node managed by the gateway and the information indicating whether the partial node function is performed by the gateway for the node has been confirmed; and
performing the partial node function for a predetermined node when the gateway information acknowledgement message is received.
